(19) United States
(12) Patent Application Publication
(10) Pub. No.: US 2025/0111220 A1
(43) Pub. Date: Apr. 3, 2025

(54) SAMPLING LARGE LANGUAGE MODELS WITH EQUIVALENCE CHECKING

(71) Applicant: Amazon Technologies, Inc., Seattle, WA (US)

(72) Inventors: Robert JONES, Beaverton, OR (US); Aaron Robert BRADLEY, Boulder, CO (US); Leah Corene DANIELS, Portland, OR (US); Leonardo Mendonça DE MOURA, Redmond, WA (US)

(21) Appl. No.: 18/374,905

(22) Filed: Sep. 29, 2023

(51) Int. Cl. G06N 3/08; G06N 3/0475

(52) U.S. Cl. CPC G06N 3/08; G06N 3/0475

(57) ABSTRACT

Generative pre-trained large language models (LLMs) can create domain-specific text answers in various formats like JSON, XML, HTML, SQL, or programming languages. However, LLMs may “hallucinate,” generating incorrect or nonsensical answers that diverge from reality, thus eroding trust in their outputs or worse. Disclosed techniques use a sampling-based approach and an equivalence checker. Multiple answers (samples) to a prompt are generated by the LLM; if they are equivalent, the LLM is likely answering correctly. If the samples disagree or contradict, it's more likely that the LLM is hallucinating, or the prompt is ambiguous. An automated reasoning equivalence checker is utilized to verify the samples' functional equivalency, providing a method to detect and possibly rectify hallucination issues in LLM-generated answers.

### BACKGROUND

The prevalence of pre-trained large language models (LLMs) is increasing. Some of these pre-trained LLMs are designed to comprehend and generate domain-specific machine-readable text (including domain-specific machine-executable text) given a natural language prompt. A challenge associated with utilizing pre-trained LLMs to generate domain-specific machine-readable text is verifying the quality and accuracy of the generated content. One approach to ascertain the quality and correctness of generated domain-specific machine-readable text is to evaluate it against a series of test cases. Regrettably, manually creating test cases proves to be both expensive and time-consuming.

### BRIEF DESCRIPTION OF DRAWINGS

Various examples in accordance with the present disclosure will be described with reference to the drawings, in which:

FIG. 1 illustrates an example of a system and method for sampling large language models with equivalence checking.

FIG. 2 illustrates an example of a system and method for sampling and cascading large language models with equivalence checking.

FIG. 3 illustrates an example of an equivalence checker to determine whether a pair of domain-specific machine-readable texts are functionally/semantically equivalent.

FIG. 4 illustrates an example of a first graphical user interface to a smart integrated development environment (IDE) that uses disclosed techniques for automatic code generation.

FIG. 5 illustrates an example of a second graphical user interface to the smart integrated development environment (IDE) that uses disclosed techniques for automatic code generation.

FIG. 6 illustrates an example of a third graphical user interface to the smart integrated development environment (IDE) that uses disclosed techniques for automatic code generation.

FIG. 7 illustrates an example of a method for sampling and cascading large language models with equivalence checking.

FIG. 8 illustrates an example of a provider network environment in which techniques for sampling and cascading large language models with equivalence checking are used.

FIG. 9 illustrates an example of a computing device used to implement techniques for sampling and cascading large language models with equivalence checking.

### DETAILED DESCRIPTION

The present disclosure relates to systems, methods, and non-transitory computer-readable storage media (collectively “techniques”) for sampling large language models with equivalence checking.

Generative pre-trained large language models (LLMs) can produce highly fluent domain-specific text responses to a diverse range of natural language prompts. Domain-specific text encompasses formats such as text structured according to data interchange standards like JavaScript Object Notation (JSON), extensible Markup Language (XML), HyperText Markup Language (HTML), or similar conventions. It also includes text formatted in accordance with query languages for structured databases (e.g., SQL, SparQL, Datalog, etc.), as well as text written in programming languages (such as Python, JavaScript, Java, C, C++, etc.). However, LLMs are susceptible to “hallucination.”

In the context of LLMs, hallucination arises when an LLM generates an answer that is inaccurate, nonsensical, or deviates from reality. Such hallucinations can erode trust in the outputs of LLMs and have the potential to lead to the spread of misinformation or cause other harm. Consequently, a technique aimed at determining whether an answer generated by an LLM is a hallucination would be highly valuable.

The techniques disclosed herein ascertain whether an LLM is experiencing hallucinations using a sampling-based approach combined with an equivalence checker for verifying the generated answers. When an LLM is proficient at providing accurate responses to a specific prompt, the multiple answers (samples) generated by the LLM in response to that prompt are anticipated to be consistent. Conversely, in cases where the LLM is hallucinating, these samples are more likely to exhibit disagreement, contradiction, or divergence among themselves. An automated reasoning equivalence checker is employed to establish whether the generated samples indeed share equivalence.

In certain instances, an LLM is subjected to multiple samplings using the same or similar prompts. The equivalence checker is then employed to ascertain whether the domain-specific text within the samples generated by the LLM possesses functional equivalence. Should these samples lack functional equivalence, it raises the possibility that either the LLM is experiencing hallucinations or that the prompt itself is ambiguous, necessitating a refinement or reformulation. Conversely, when the samples exhibit functional equivalence as determined by the equivalence checker, it serves as an indicator that the LLM is proficiently capable of generating coherent responses.

While in some examples the equivalence checker is employed to ascertain whether LLM generated domain-specific texts possess functional equivalence (e.g., have the same behavior or produce the same outputs for all possible inputs and states) which is sometimes referred to as semantic equivalence, the equivalence checker can check for other types of equivalence or relationships between domain-specific texts. For example, the equivalence checker can check for syntactic equivalence between texts or model equivalence (e.g., whether texts are equivalent with respect to a specified property) or whether one text implies another text. More generally, what it means for domain-specific texts to be equivalent can vary from application to application according to the requirements of the particular implementation at hand. Nonetheless, broadly speaking, equivalence exists where domain-specific texts have the same meaning in a domain to which the texts belong.

By way of illustrating the issue addressed within this context, consider a scenario where a business aims to leverage an LLM to produce domain-specific text, serving the implementation of diverse information technology projects. However, as previously mentioned, the utilization of an LLM in generating such text introduces the concern of hallucinations-instances where the LLM generates domain-specific text that might (or might not) appear accurate on the surface but is ultimately nonsensical or incorrect. Consequently, the advantages associated with employing an LLM for text generation in this context, such as reduced development time, could be outweighed by the expenses incurred by the business in establishing a thorough quality assurance and testing regimen to ensure the precision and dependability of the LLM-generated text. LLM-induced hallucinations can yield malfunctioning code, leading to bugs, errors, and squandered development efforts. The techniques divulged herein mitigate or eradicate the necessity for quality assurance and testing of LLM-generated domain-specific text through a sampling procedure that employs automated reasoning (equivalence checking) to differentiate between instances where the LLM is experiencing hallucinations, the prompt is ambiguous, and the generated text is coherent.

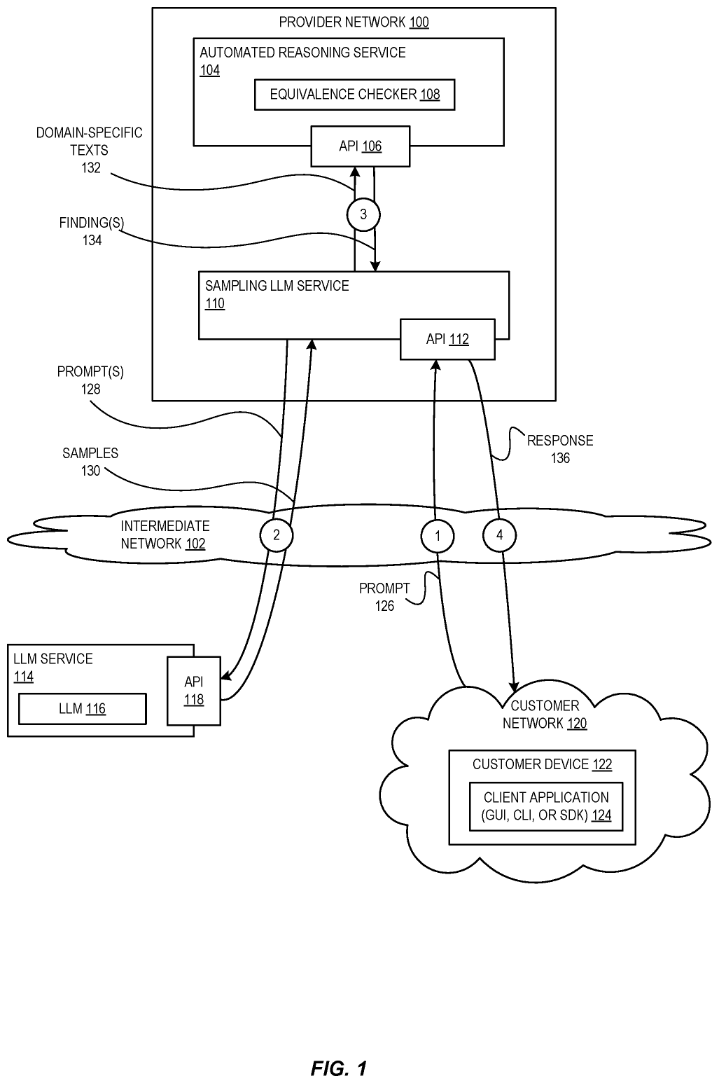

FIG. 1 depicts an exemplar of a system and method for sampling large language models with equivalence checking. The configuration presented in FIG. 1 encompasses a provider network denoted as “Provider Network 100.” This network, often referred to as a “cloud” provider network, extends users the capability to leverage a diverse range of computing-related resources. These resources encompass compute elements, such as the execution of virtual machine (VM) instances or containers, undertaking batch jobs, and running code sans the need for server provisioning. Additionally, data and storage resources are encompassed, comprising object storage, block-level storage, archival data storage, databases, and database tables, among others. Network-related assets, like the setup of virtual networks that encompass clusters of compute resources, content delivery networks (CDNs), and Domain Name Service (DNS), are also part of this network. Application resources such as databases and services for application building and deployment are integral components. The network includes provisions for access policies, roles, identity policies, machine images, routers, and various other data processing resources, forming a comprehensive suite of capabilities offered to users.

These computing resources, among others, are available through provider network 100 as services. For instance, this includes a hardware virtualization service capable of executing compute instances and a storage service designed to store data objects. The individuals utilizing provider network 100, often referred to as “users” or “customers,” can make use of one or more user accounts that are linked to a customer account. Although these terms may be used interchangeably depending on the context, they collectively represent the association between users and the provider network. Users can engage with provider network 100 through intermediary networks 102, which could be the internet, utilizing diverse interfaces. These interfaces encompass interacting via application programming interface (API) calls or utilizing a console implemented as a website or application, among other methods.

An API, short for Application Programming Interface, denotes an interface or communication protocol that facilitates interaction between a client and a server. When a client submits a request in a predetermined format, it anticipates receiving a response in a specific format or instigating a predefined action. Within the context of provider network 100, APIs serve as gateways enabling customers to access the infrastructure and resources within the network. This access empowers customers to retrieve data from or initiate actions within provider network 100, fostering the creation of applications that engage with the resources and services hosted within the network. APIs additionally facilitate the exchange of data among various services within provider network 100. These APIs can constitute an integral component of, or operate as a front-end for, the control plane of provider network 100. This control plane comprises “backend” services that provide support and enable the more direct delivery of services to customers.

By way of illustration, provider network 100 typically alludes to an extensive repository of accessible virtualized computing resources, encompassing compute, storage, networking resources, applications, and services. Provider network 100 facilitates streamlined, on-demand network entry to a shared pool of configurable computing resources. These resources can be programmatically allocated and released based on customer directives. The flexibility of these resources enables them to be dynamically provisioned and reconfigured to accommodate fluctuating workloads. In this manner, provider network 100 can be perceived as encompassing both applications delivered as services over publicly accessible networks (e.g., the Internet, cellular communication networks) and the hardware and software situated within data centers, facilitating the delivery of said services.

Provider network 100 furnishes an automated reasoning service denoted as “automated reasoning service 104.” This service capitalizes on automated reasoning techniques to resolve problems and facilitate automated decision-making. These techniques encompass algorithms and systems adept at deriving logical inferences, resolving intricate problems, and autonomously executing decision-making functions. The provision of automated reasoning service 104 extends to other services within provider network 100 through API 106. This integration empowers these services to embed automated reasoning capabilities within their own applications and systems, sparing them the need to construct the foundational automated reasoning techniques from scratch.

Automated reasoning service 104 finds utility in diverse applications, such as validating the accuracy of mathematical theorems or logical statements using formal methods and logical deductions (e.g., theorem proving), assessing and confirming the behavior of hardware or software systems against specified properties or requirements (e.g., model checking), devising plans or sequences of actions to achieve specific goals or objectives in dynamic and uncertain settings (e.g., automated planning), identifying solutions to problems entailing constraints and variables—like scheduling, resource allocation, or configuration dilemmas (e.g., constraint solving)—employing formal logic systems to deduce conclusions or address queries based on provided facts and rules (e.g., logic-based reasoning), structuring and processing knowledge systematically to provide answers and make decisions (e.g., knowledge representation and reasoning), and other suitable applications.

Within the framework of automated reasoning service 104, there exists equivalence checker 108. Equivalence checker 108 is structured to ascertain whether a given pair of domain-specific texts hold functional/semantic equivalence. To illustrate, this pair of texts might comprise two code samples pertaining to the same prompt, originating from a large language model. Equivalence checker 108 undertakes the task of verifying whether these two code samples yield identical outputs across all conceivable inputs.

The term “domain-specific text” is intended to encompass text that text is formatted in a domain specific language (DSL). A domain-specific language (DSL) can be a programming language or specification language that is designed and tailored to solve problems within a specific domain, industry, or problem space. For example, domain-specific text can be formatted as JSON, XML, HTML, or other markup language; as SQL or other database query language; or as Python, Java, JavaScript, or other programming language. However, there is no requirement that domain-specific text be formatted in a standard or well-known domain-specific language and domain-specific text can encompass text that is formatted in a proprietary or single purpose domain-specific language, or a domain-specific language designed for use with a single application. Domain-specific text includes domain-specific machine-readable text. Domain-specific machine-readable text encompasses domain-specific text that is structured and formatted in a way that is easily understandable by machines, particularly computers and automated systems. This type of text is designed to be processed, analyzed, and interpreted by software applications more quickly and more accurately than natural language text.

While there is no precise delineation between domain-specific machine-readable text and a natural language text, domain-specific machine-readable text is designed for automated processing and is typically structured using specific formats, while natural language text is geared toward human communication and contains a richness of meaning that requires sophisticated tools and techniques for computer-based understanding. Natural language text often has more ambiguity requiring contextual understanding based on context or cultural knowledge to properly interpret compared to domain-specific machine-readable text. Prompts requesting to generate domain-specific machine-readable text submitted to a large language model may be formatted as a natural language text, as domain-specific machine-readable text, or as a combination of natural language text and domain-specific machine-readable text.

Equivalence checker 108 may employ various automated reasoning techniques to analyze the pair of domain-specific texts and explore all possible scenarios to ensure exhaustive and systematic functional/semantic equivalence. In some examples, equivalence checker 108 employs formal methods. Formal methods involve the use of mathematical techniques, such as symbolic model checking, theorem proving, a Boolean satisfiability (SAT) solver, or a satisfiability modulo theories (SMT) solver, to formally verify equivalence. Additionally, or alternatively, formal methods may involve the use of rewriting systems. For example, a set of semantics-preserving rewriting rules that capture valid transformations of the domain-specific texts can be applied to the texts to mutate the texts to normalized forms. The normalized forms can be compared to determine whether the domain-specific texts are functionally/semantically equivalent. For example, the domain-specific texts may be determined to be functionally/semantically equivalent if they have identical normalized forms.

In certain examples, equivalence checker 108 encodes the pair of domain-specific texts into logical formulas. It can subsequently determine whether the pair of domain-specific texts is functionally/semantically equivalent by applying an automated theorem prover to the logical formulas. Furthermore, equivalence checker 108 can utilize model-checking techniques to verify functional/semantic equivalence. Via model checking, equivalence checker 108 can systematically explore the state space of the pair of domain-specific texts to verify their functional/semantic equivalence.

While examples here discuss pairwise comparison of domain-specific texts to each other for functional/semantic equivalence, the techniques are not limited to such pairwise comparison. For example, for a given set of domain-specific texts, each text can be converted to a canonical or normalized form with a goal of capturing the functional essence of the text, removing extraneous details or variability. The canonical or normalized forms can then be compared to each other. For example, the domain-specific texts may be deemed functionally/semantically equivalent if all their canonical or normalized forms are identical or equivalent.

The LLM service 114 is a cloud-based or online service that grants access to a corresponding large language model (LLM) 116. LLM 116 has been trained on an extensive amount of textual data and can perform a diverse array of natural language processing tasks, including, but not limited to: text completion, language translation, question-answering, and sentiment analysis. LLM service 114 is made available on a network (e.g., intermediate network 102) through its respective API 118. API 118 enables application developers to seamlessly integrate the capabilities of LLM 116 into their own applications, products, or services, eliminating the need to host and train LLM 116 themselves.

The LLM 116 could be categorized as a type of artificial intelligence model engineered to comprehend and produce text based on an extensive volume of training text data. LLM 116 is potentially a deep learning model, possibly adopting a transformer architecture, with the capability to process and generate natural language textual information. It might encompass a substantial number of model parameters, potentially reaching into the billions. In general, a greater number of parameters tends to result in improved performance of LLM 116 in terms of generating accurate text across a wide spectrum of prompts. Nevertheless, an LLM 116 with a fewer number of model parameters has the potential to generate responses that are equally accurate or even more accurate than an LLM with a higher number of model parameters, in certain cases. However, it's important to note that more parameters correspond to increased costs, environmental impact, and energy consumption associated with LLM 116.

The LLM prompt 126 can be transmitted to the API 112 of the LLM sampling service 110 from the customer device 122 situated within the customer network 120. This customer device 122 might take the form of a personal computing device, such as a desktop computer, laptop computer, tablet, or mobile phone, which is equipped with the client application 124. This client application 124 facilitates the provision of the LLM prompt 126 and could offer support for a graphical user interface (GUI), a command-line interface (CLI), or even a software development kit (SDK) to facilitate the submission of LLM prompt 126. As an example, the client application 124 could manifest as a web application, a web browser application, a mobile app, or another software program executed on the customer device 122.

The customer network 120 might encompass various configurations, including a local area network (LAN), a virtual private network (VPN), or any suitable form of data communication network, through which the customer device 122 can engage in data exchange with the provider network 100 via the intermediary network 102 (such as the internet).

The method of FIG. 1 is depicted by numbered circles overlaying directed arrows. The direction of the arrows represents a direction of data flow but not necessarily the exclusive direction. The numbers in the circles are merely labels for various operations of the method. The numbers are not intended to imply an exclusive ordering operations or imply that operations cannot overlap in execution or be performed concurrently or in parallel.

During operation 1, the prompt 126 is dispatched from within the customer network 120, subsequently transmitted across the intermediate network 102, and eventually received by the sampling LLM service 110 through the API 112. In certain instances, the prompt 126 embodies a natural language specification intended for the generation of domain-specific text by an LLM.

In some scenarios, the domain-specific text to be generated by an LLM according to the prompt 126 falls within a specific domain, which encompass: (1) a text-based structured data interchange format, (2) a text-based structured database query language, or (3) code expressed in a specific programming language. Illustrative examples of text-based structured data interchange formats that prompt 126 could solicit encompass JavaScript Object Notation (JSON), extensible Markup Language (XML), and HyperText Markup Language (HTML). To provide a straightforward example, prompt 126 might instruct an LLM to craft JSON data representing an employee roster, complete with names, ages, departments, and a list of assigned projects. As another example, prompt 126 might instruct an LLM to generate statements directly in logic such as propositional logic, first-order logic, or modal logic. For example, prompt 126 might ask a LLM to “express the statement ‘if it is raining, then the ground is wet’ in propositional logic.” In this case, the LLM might generate domain-specific text such as “Let p represent ‘it is raining’ and q represent ‘the ground is wet’. The statement can be expressed as: p→q.”

Furthermore, the types of textual prompts that the domain-specific text might entail extend to structured database query languages. For instance, prompt 126 might instruct an LLM to generate a Structured Query Language (SQL) query, which retrieves names and ages of employees from the “employees” table who are over 30 years of age and belong to the “Sales” department.

Additional examples lie in the realm of programming languages, where prompt 126 might require code generation for languages such as Python, Java, C, C++, JavaScript, C#, PHP, Swift, Ruby, Go, R, Kotlin, TypeScript, and more. As a simple illustration, prompt 126 might task an LLM with producing Python code designed to calculate the factorial of a positive integer ‘n’.

During operation 2, the sampling LLM service 110 conducts multiple samplings of the LLM 116 using the prompt 128. This process involves dispatching the prompt 128 through the intermediate network 102 to the API 118 of the LLM service 114, subsequently retrieving one or more sample answers, generated by LLM 116 and provided by LLM service 114, through the same intermediate network 102. The act of sampling LLM 116 may encompass various steps, such as transmitting prompt 128 and then receiving corresponding sample answers from the LLM service 114.

The prompt 128 might entail a request for LLM 116 to produce multiple sample answers, thereby generating a series of samples. Alternatively, the approach could involve transmitting the prompt 128 multiple times to the LLM service 114, with each occurrence leading to the generation of a sample answer by the LLM 116 and the subsequent return of said sample answer from the LLM service 114, in response to the prompt 128.

The prompt 128 could either mirror prompt 126 or be derived from it. As an example, prompt 128 may represent a pre-processed iteration of prompt 126. Within the sampling LLM service 110, a prompt pre-processing engine may be in place to carry out the transformation of prompt 126 into prompt 128. This pre-processing engine may be capable of executing one or more optimizations on prompt 126, leading to the creation of prompt 128.

These optimizations could encompass the incorporation of pertinent details into prompt 128, such as variable names, function names, input/output requirements, and the intended behavior. Furthermore, the pre-processing engine may incorporate inputs and their corresponding expected outputs within prompt 128. This inclusion serves to enhance LLM 116's comprehension of the sought-after functionality and to aid in the generation of domain-specific text capable of generating the anticipated outcomes.

Moreover, the pre-processing engine may introduce information related to the specific problem, domain, or scenario into prompt 128. This augmentation is designed to guide LLM 116 in aligning its answer generation with the context, thereby yielding domain-specific text tailored to the intended purpose. Additionally, the pre-processing engine could incorporate specifications for coding styles, encompassing aspects such as indentation or naming conventions, directly into prompt 128.

Finally, the pre-processing engine may embed a specification for the “temperature” parameter of LLM 116 within prompt 128. This temperature parameter plays a role in controlling the randomness of LLM 116's output and could influence the degree of diversity present in the generated responses.

The “temperature” parameter serves as a configuration within certain large language models (LLMs), enabling the regulation of output randomness during text generation. Its role is to guide the LLM's decision-making when selecting the subsequent word or token during the process of text generation. A heightened value assigned to the temperature parameter introduces greater diversity and creativity into the generated output. This prompts the LLM to explore a wider array of possibilities, yielding text that exhibits more pronounced variations. However, this heightened diversity might also translate to output that is occasionally more random and less coherent.

Conversely, a reduced temperature value directs the output towards a more focused and determined outcome. In such cases, the LLM is inclined to favor the most probable next token based on its training data, thereby generating text that is more predictable and well-controlled.

In specific scenarios, when the pre-processing engine incorporates a temperature parameter value into prompt 128, a lower value (e.g., ranging from 0.2 to 0.5 inclusively) is employed. This choice serves to guide LLM 116 in producing domain-specific text that is more concentrated and deterministic in nature.

In certain instances, LLM 116 undergoes multiple samplings using an identical prompt 128, resulting in the acquisition of various sample answers. Conversely, in other cases, LLM 116 is sampled multiple times employing marginally altered prompts. As an illustration, when LLM 116 is sampled with prompt 128, one or more prompts utilized to elicit sample answers from LLM 116 might exhibit slight variations from prompt 128. These variations are strategically introduced to avoid impacting the functional/semantic equivalence of the ensuing sample answers. If the sample answers produced by LLM 116 for these subtly divergent prompts maintain functional/semantic equivalence, it underscores LLM 116's capacity to generate coherent responses. This outcome underscores LLM 116's ability to perceive that the nuanced deviations in the prompts do not interfere with the functional integrity of the sample answers.

To illustrate this concept, consider a scenario where prompt 126 mandates the creation of a Python function for calculating the factorial of a non-negative integer ‘n’. In this case, three distinct sample answers might be extracted from LLM 116 for three distinct prompts. These prompts might differ in their request to generate a Python function for computing the factorial of ‘n’ using either recursion, iteration (e.g., employing a for loop or a while loop), or the math.factorial function from the Python standard library. Despite these varied prompts, the expectation remains that all three sampled answers are functionally/semantically equivalent, yielding consistent outcomes across all feasible inputs. Should LLM 116 indeed succeed in producing functionally/semantically equivalent sample answers for these diverse prompts—prompts that deviate in ways inconsequential to the functional/semantic equivalence—it suggests that LLM 116 is likely free from hallucinatory responses with respect to the prompt 126 at hand.

Additionally, within operation 2, LLM service 114 furnishes the sampling LLM service 110 with sample answers 130. Each of these sample answers may encompass domain-specific text, generated by LLM 116 in direct response to prompt 128 or one among the prompts 128, if multiple prompts are employed for the purpose of sampling LLM 116.

In operation 3, domain-specific texts 132, drawn from the sample answers 130, are transmitted to the automated reasoning service 104 via its API 106. For each provided pair, the automated reasoning service 104 triggers the equivalence checker 108 into action, aiming to ascertain the functional/semantic equivalence of the text pair. The outcome of this evaluation, furnished by equivalence checker 108, constitutes a determination for the given pair. This determination signifies whether the two texts in the pair are functionally/semantically equivalent. Furthermore, if the determination suggests that the text pair is not functionally/semantically equivalent, the result may encompass a “witness.” This “witness” could encapsulate a precise assignment of values to the variables within the texts of the pair, effectively demonstrating the lack of functional/semantic equivalence. To illustrate, in cases where the two texts represent distinct programs within a programming language, the determination could include an assignment of values to the programs' inputs, resulting in divergent outputs as determined by equivalence checker 108. The witness may comprise a counterexample of functional/semantic equivalence of the two texts. For example, the counterexample may comprise a specific assignment of inputs that the equivalence checker 108 determines would cause the texts when executed or otherwise processed to produce different outputs.

In certain scenarios, when the sample answers 130 encompass more than two domain-specific texts, a comparison process is undertaken. A text within the sample answers 130 may be individually evaluated for functional/semantic equivalence against another text of sample answers 130, or the comparisons may occur in a pairwise manner.

For instance, when the sample answers 130 consist of four texts (A, B, C, D), the equivalence checker 108 may be called upon to determine functional/semantic equivalence for the pairs of texts: (A, B), (A, C), and (A, D), assuming text A serves as a reference. For every such pair, equivalence checker 108 generates a finding of finding(s) 134.

Moreover, if texts of texts 132 are ascertained by equivalence checker 108 as not being functionally/semantically equivalent, then equivalence checker 108 may forego evaluating the functional/semantic equivalence of any remaining texts of texts 132. It is important to note that the assessment of texts 132 by equivalence checker 108 can be conducted concurrently or in parallel, depending on the specific implementation.

Moving to operation 4, the sampling LLM service 110 determines the response 136 to deliver, guided by the finding(s) 134. These finding(s) 134, possibly one for each evaluated pair of texts within texts 132, encapsulate the results generated by equivalence checker 108.

In certain instances, if a finding within finding(s) 134 indicates that at least one pair of texts of texts 132 lacks functional/semantic equivalence, response 136 can incorporate the witness supplied by equivalence checker 108. This witness could be shared with the user of the customer device 122 through the client application 124. The intention here is to assist the user in refining or rephrasing the initial prompt 126. Subsequently, the refined or rephrased prompt or a prompt derived therefrom can be submitted anew to the sampling LLM service 110, facilitating a fresh attempt with the enhanced prompt.

In contrast, when the finding(s) 134 indicate(s) that all texts 132 are functionally/semantically equivalent, response 136 could encompass one or more of the texts 132. The text(s), integrated into response 136, could be showcased to the user of the customer device 122 through the client application 124. For instance, a text might be displayed within a graphical user interface (GUI) of an integrated development environment (IDE) application.

In certain scenarios, equivalence checker 108 is called upon to validate the functional/semantic equivalence of a set of domain-specific texts. To accomplish this, equivalence checker 108 has the capability to translate both texts into corresponding logical formulas. These logical formulas serve as structured representations of the texts, amenable to comprehension by automated theorem provers like SMT solvers. This translation process may encompass Equivalence checker 108 encoding diverse aspects such as control flow, data operations, input/output behavior, and other logical properties as logical constraints within the formulated logical formulas.

As an illustration, the texts can undergo translation into various logical frameworks including propositional logic, first-order logic, arithmetic, arrays, bit-vectors, and other theories employed within formal verification and automated reasoning, all in accordance with the Satisfiability Modulo Theories Library (SMT-LIB) format and language. SMT-LIB stands as a standardized format and language designed for delineating logical theories and formulas meant for utilization with SMT solvers. This standardized format provides a unified platform enabling users to articulate logical problems in a consistent and transferable manner, fostering the interchangeability of both problems and solvers.

In certain instances, the domain-specific texts undergo translation into a logic framework embedded within the SMT-LIB language. Such frameworks might include quantifier-free with uninterpreted functions (QF_UF), quantifier-free with arrays and bit-vectors (QF_AUFBV), quantifier-free linear integer arithmetic (QF_LIA), quantifier-free linear real arithmetic (QF_LRA), or any other applicable SMT-LIB logic. The choice of which specific logic to employ can fluctuate based on the unique considerations of the particular implementation in question. This encompasses factors such as the specific prerequisites of the problem at hand and the elements incorporated within the logical formulas.

Once equivalence checker 108 has encoded the pair of domain-specific texts, it proceeds to formulate an equivalence query. In certain scenarios, this equivalence query takes the form of a logical formula, which embodies the negation of equivalence between the two texts as represented by their encodings. In simpler terms, the equivalence query affirms that the two texts lack functional/semantic equivalence, and it presents this query to an SMT solver, inquiring whether a satisfying assignment can be identified for the query.

Should the SMT solver indeed locate a satisfying assignment for this query, it substantiates that the two texts are not functionally/semantically equivalent. The located satisfying assignment may be provided as the witness in the finding returned by the SMT solver. Conversely, if the SMT solver deems the equivalence query unsatisfiable, this outcome signifies that the two texts are indeed functionally/semantically equivalent.

In certain instances, equivalence checker 108 triggers the SMT solver into action by providing the formulated query as input. The SMT solver undertakes an exhaustive exploration for a satisfying assignment, aiming to establish the status of the equivalence query-whether it is satisfiable (indicating non-functional/semantic equivalence of the two texts) or unsatisfiable (implying functional/semantic equivalence of the two texts).

In certain scenarios, the outcome conveyed by finding(s) 134, which equivalence checker 108 returns, communicates whether the equivalence query was determined to be satisfiable or unsatisfiable. When the equivalence query is adjudged unsatisfiable, it substantiates the functional/semantic equivalence of the two texts. Conversely, when the equivalence query is identified as satisfiable, the finding might encompass a satisfying assignment, serving as evidence of the non-equivalence, commonly referred to as a “witness”.

However, in certain scenarios, equivalence checker 108 employs an alternative automated reasoning tool, distinct from an SMT solver, to assess functional/semantic equivalence between two texts. This approach could be utilized either independently or as a supplementary method alongside the SMT solver. For instance, equivalence checker 108 might engage a symbolic model checker or other comparable semi or fully automated technique specifically designed for equivalence verification.

In some examples, equivalence checker 108 is a sequential equivalence checker or a combinational equivalence checker. In both cases, equivalence checker 108 verifies whether two different domain-specific texts are functionally/semantically equivalent. In other words, for the same inputs, the two texts, when executed, interpreted, or otherwise processed, produce the same outputs. Note that functional/semantic equivalence does not require that the two texts implement a function in the same way. Indeed, the two texts may be sampled from an LLM or multiple LLMs with different respective prompts that are intended to implement a function in different ways. For example, one prompt may request a function that computes the factorial of ‘n’ recursively and another prompt may request a function that computes the factorial of ‘n’ iteratively. The texts for both prompts can be functionally/semantically equivalent even though they implement the function in different ways.

For a sequential equivalence checker 108, checker 108 may first represent the domain-specific texts in a form that captures their sequential logic or functionality. For example, the texts could be translated into state machines where states represent conditions or stages, and transitions are driven by the rules or instructions contained within the texts. Checker 108 may also identify inputs and outputs, where the inputs are the conditions or variables that the texts operate on, and the outputs are the resulting actions or conclusions. Specifically, checker 108 may verify that the texts have the same set of input and output parameters. Checker 108 may define how the state systems of the texts move from one state to another based on inputs and current states. Then, checker 108 may compare the state machines representing the two texts, examining all possible sequences of inputs and states to ensure that, for the same sequence of inputs, both state machines reach equivalent states and produce the same outputs. For large state machines, checker 108 may use techniques like abstraction, bi-simulation, or symbolic execution to make the equivalence checking problem more tractable. If checker 108 finds that the two state machines are equivalent, it may produce a finding that the two texts are functionally/semantically equivalent. If not, checker 108 may produce a finding that identifies where the differences lie, which can help a user, or an automated process determine if the functional inconsistencies between the two texts are the result of an ambiguous prompt or because of a hallucinating LLM.

For a combinatorial equivalence checker 108, checker 108 may analyze two texts by translating them into mathematical representations that capture the logic described by the texts. By comparing these representations, checker 108 would verify that the texts describe the same relationships between specific inputs and outputs, without considering sequence or state, thereby verifying that the texts are functionally/semantically equivalent, even if they are expressed or structured differently. Checker 108 may compile or translate the texts into a form that captures the logic or functionality described. For example, checker 108 may translate the texts into logical expressions, logical formulas, or other mathematical representations that detail the relationship between inputs and outputs. Additionally, or alternatively, checker 108 may convert the texts into a combinational logic representation, like a Boolean function, that captures the relationships between inputs and outputs. For example, this could be a direct mapping of every possible input combination to the corresponding output. Checker 108 may compare the combinatorial representations of the two texts using methods such as a Binary Decision Diagram (BDD), a Boolean satisfiability (SAT) solver, or a satisfiability modulo theories (SMT) solver. For large or complex texts, direct comparison may be computationally difficult. In this case, advanced techniques and heuristics may be required to efficiently determine equivalence. If the two texts are found to describe the same logic irrespective of sequencing, performance, or timing, then checker 108 can declare the two texts functionally/semantically equivalent. Otherwise, checker 108 may find non-functional/semantic equivalence and report a difference between the two texts (e.g., a witness).

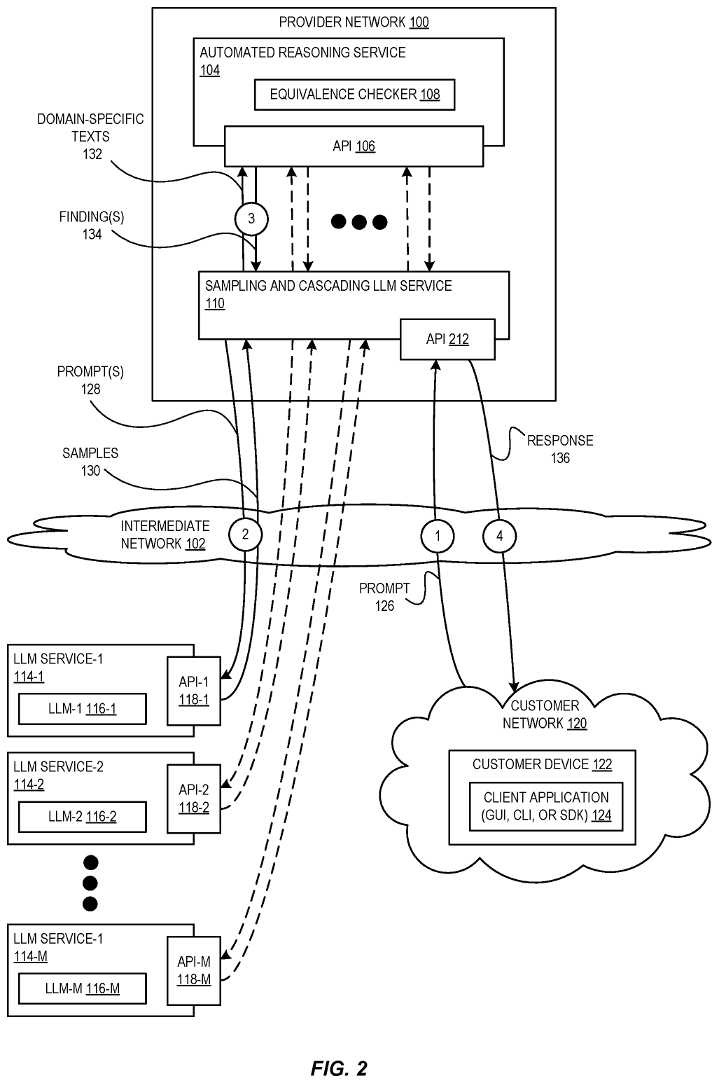

FIG. 2 illustrates an exemplary system and methodology for both sampling and cascading large language models while incorporating equivalence checking. In addition to its capacity for sampling LLMs, service 110 is configured to cascade these LLMs. The financial implications, environmental considerations, and energy repercussions associated with obtaining an accurate output from a large language model (LLM) service hold significant importance with regards to the utility of such a service. Regrettably, one often lacks prior insight into which specific LLM service, from a set of available alternatives, will deliver a precise response at a reasonable cost. This underscores the necessity for a technique capable of selecting one or more LLM services in an optimized manner, considering the cost factor.

This requirement for a selection technique is coupled with the imperative of validating the correctness of a generated response.

Within certain instances, service 110 furnishes a cost-optimized approach for selecting LLM services, all the while employing equivalence checker 108 for the validation of generated answers. In some scenarios, the array of LLM services 114-1, 114-2, . . . , 114-M is arranged in ascending order based on their costs. When confronted with the task of addressing prompt 126, the most economical LLM service candidate is subjected to sampling in line with the process elucidated in FIG. 1. This endeavor yields samples 130 that are responsive to prompt 126 from the selected LLM service.

Equivalence checker 108 then steps into action, appraising the functional/semantic equivalence of samples 130. Should they fail to exhibit functional/semantic equivalence, the ensuing course of action entails moving on to the next candidate LLM service, characterized by a slightly higher cost. The method of generating samples from this subsequent candidate LLM service mirrors the process outlined in FIG. 1. Subsequently, equivalence checker 108 is once again harnessed to determine whether the fresh set of samples showcases functional/semantic equivalence.

This iterative sequence of sampling, focused on the ordered array of candidate LLM services, can persist until either equivalence checker 108 verifies the functional/semantic equivalence of samples from a given LLM service or until a predefined stopping condition is met, such as reaching or surpassing a stipulated cost threshold. If the lower-cost LLM service indeed succeeds in generating functionally/semantically equivalent samples, this approach can lead to significant cost savings as opposed to directly engaging a higher-cost LLM service from the outset.

By way of illustrating a problem under discussion, consider a scenario of a high-performance LLM service that levies charges based on the extent of the prompt, the length of the generated answer, and a fixed fee for utilizing its application programming interface (API). With the objective of generating top-tier texts, the business might prefer to resort to the high-performance LLM service. Nevertheless, there lies an opportunity for cost reduction if a more economical LLM service can deliver the desired caliber of texts at a lower expense.

In certain instances, service 110 introduces an approach characterized by economical and authenticated utilization of LLM services. This method encompasses a cascading strategy, wherein from the array of multiple available LLM service options (114-1, 114-2, . . . , 114-M), one or more are systematically sampled in a sequential manner for a specific prompt. Upon subjecting the sample texts generated by an LLM service to verification by equivalence checker 108, those that are confirmed to be functionally/semantically equivalent form the basis for generating answers to prompt 126. In such cases, there is no need to invoke further LLM services for addressing prompt 126. Subsequent LLM services are only sampled when the earlier sampled LLM services yield sample texts that equivalence checker 108 does not ascertain as functionally/semantically equivalent.

When applied across a substantial range of prompts, this method holds the potential to considerably curtail LLM service costs. The attainment of verified answers for numerous prompts through the lowest or more economical LLM services could lead to substantial cost savings. Moreover, the implementation of this approach also bears a positive impact on environmental and energy considerations.

In certain scenarios, service 110 undertakes its operations at operation 1 by receiving an assortment of large language model (LLM) prompts. This assortment might encompass an array of prompts, including those that involve code generation. Each of these prompts encapsulates a natural language expression or another high-level specification of code, destined for a LLM service to process to generate in a domain-specific or alternative lower-level language (e.g., Structured Query Language (SQL) queries). Once acquired, this collection of prompts is dispatched by service 110 to a range of LLM services, leading to the generation of corresponding answers to the prompts by these LLM services.

As previously indicated, for each prompt, service 110 may adopt at operation 2 an iterative sampling approach involving one or more LLM services. This sequential process continues until one of the LLM services returns a set of samples that exhibit functional/semantic equivalence (operation 3) or until a predetermined stopping criterion is met. This stopping criterion could encompass factors such as the cost budget allocated for the LLM prompt or the aggregate set of prompts, with further LLM services being engaged only if it does not exceed the predefined budget.

In the goal of ascertaining the functional/semantic equivalence of generated pairs of samples stemming from an LLM service at operation 3, service 110 leverages the equivalence checker 108 within the automated reasoning service 104, via the API 106.

During operation 3, if finding(s) 134 regarding the domain-specific texts 132 of the sample answers 130 confirm their functional/semantic equivalence, service 110 advances to operation 4. In operation 4, it initiates the provision of response 136. This response 136 encompasses the act of returning either one or more samples 130 or one or more texts 132 extracted from these samples.

Conversely, at operation 3, when finding(s) 134 concerning texts 132 determine their absence of functional/semantic equivalence, service 110 adopts an alternative approach. It proceeds to systematically sample the subsequent LLM services in sequential order, encompassing entities like LLM services 114-2, . . . , 114-M.

During operation 3, equivalence checker 108 establishes that texts 132 possess functional/semantic equivalence and conveys finding(s) 134 back to service 110. In operation 4, response 136 can comprise one or more of texts 132 if equivalence checker 108 verifies their functional/semantic equivalence. Alternatively, if equivalence checker 108 concludes that texts 132 are not functionally/semantically equivalent, a different course unfolds.

In such a scenario, the sampling of remaining LLM services continues systematically, proceeding in order until either one of the services returns a set of samples determined to be functionally/semantically equivalent or a predetermined stopping criterion is met. An example of this stopping criterion could be a budget constraint, such as a predefined cost limit. For instance, a customer might have a specified monthly or daily cost budget or per-query cost budget associated with service 110. This budget serves as an upper limit on the expenditure incurred by the customer through the sampling of LLM services 114-1, 114-2, . . . , 114-M using prompts supplied by the customer within a designated time period.

Service 110 may halt the sampling of LLM services 114-1, 114-2, . . . , 114-M for the remainder of the budget period if the act of sampling another LLM service would result in surpassing the budget for the period, or if the budget has already been exceeded. Upon the expiration of the budget period and the availability of a fresh budget for a subsequent period, service 110 can recommence the process of sampling LLM services 114-1, 114-2, . . . , 114-M using prompts provided by the customer. The utilization of a cost budget proves particularly apt in situations where the customer submits a fluctuating or unpredictable volume of prompts to service 110 on a daily, weekly, monthly, or otherwise defined basis. For example, a volume of prompts may be submitted to service 110 during off-hours (e.g., early morning hours) when compute costs are cheaper.

LLM services 114-1, 114-2, . . . , 114-M exhibit diverse performance and cost characteristics, along with varying strengths and weaknesses across different prompts. As a result, judiciously selecting the appropriate LLM service from this set (114-1, 114-2, . . . , 114-M) can yield advantages such as cost reduction, performance enhancement, and a reduction in energy consumption and environmental impact. Note that while examples discuss sampling and cascading over multiple LLM services 114-1, 114-2, . . . , 114-M, the techniques can be equivalently applied to sampling the same LLM or the same LLM service with multiple different configurations where each different configuration is selected for a particular performance versus cost tradeoff. For example, three different configurations may be used where one configuration is high performance and high cost, another is balanced performance and balanced cost, and yet another is low performance and low cost.

Service 110 operates by sequentially dispatching a prompt, received through API 112, to sample the array of LLM services (114-1, 114-2, . . . , 114-M). Should any of these LLM services (114-1, 114-2, . . . , 114-M) return a set of sample answers verified by equivalence checker 108 to be functionally/semantically equivalent, then one or more of these sample answers can constitute the response to the prompt. Subsequently, there is no necessity to sample additional LLM services from the set (114-1, 114-2, . . . , 114-M).

In certain instances, service 110 forwards the prompt to the remaining LLM services (114-1, 114-2, . . . , 114-M) exclusively if the set(s) of sample answers, received from the previously invoked LLM services (114-1, 114-2, . . . , 114-M), fail the verification by equivalence checker 108 for functional/semantic equivalence.

Service 110 possesses the capability to cascade a given prompt across the spectrum of LLM services, namely LLM services 114-1, 114-2, . . . , 114-M, employing diverse orders for this process. One method of ordering the LLM services (114-1, 114-2, . . . , 114-M) involves arranging them based on their associated costs, progressing from the lowest cost to the highest cost. The cost associated with each of these LLM services (114-1, 114-2, . . . , 114-M) for every given prompt could be contingent upon one or more factors, such as the token length of the prompt, the token length of the generated answer, and a fixed cost. Consequently, LLM services (114-1, 114-2, . . . , 114-M) can be categorized in terms of various metrics, including the average cost per prompt, the mean cost per prompt, or any other relevant cost per prompt measurement.

During the cascading process, the initial LLM sampled might furnish a collection of sample answers that are subsequently ascertained to lack functional/semantic equivalence. This situation raises the question of whether the absence of functional/semantic equivalence among the sample answers can be attributed to either (1) the inherent ambiguity of the prompt, or (2) the incapability of the LLM to accurately respond to the prompt (e.g., exhibiting hallucinatory behavior). In response to this dilemma, service 110 can implement a range of strategies to tackle the underlying concern.

One strategy involves employing a machine learning model, such as a regression model, designed to discern between two scenarios: (1) the necessity of refining or reformulating the prompt, followed by a resampling of the same LLM with the revised prompt, or (2) advancing the cascading procedure to a different LLM that is more likely to produce a coherent response. This model can be trained on a dataset encompassing both ambiguous and unambiguous prompts, utilizing a supervised learning approach. Once trained, the model can perform classifications to determine whether a given prompt is likely to be ambiguous or not.

Should the evaluation classify the given prompt as ambiguous, it suggests that the prompt necessitates refinement or reformulation before resubmission to the same LLM. Service 110 is empowered to prompt the user to undertake this task, or alternatively, it can undertake an automatic refinement or reformulation of the prompt itself. In certain instances, service 110 can leverage the findings generated by the equivalence checker to determine the optimal approach for refining or reformulating the prompt. Specifically, the witness provided within the finding can guide service 110 in this regard. For instance, the witness might highlight an ambiguity within the prompt. In scenarios where user involvement is required for prompt refinement or reformulation, service 110 can offer the witness as a reference, enabling users to detect and rectify any ambiguities while refining or reformulating the prompt.

On the contrary, if the model determines that the given prompt lacks ambiguity, service 110 can either automatically proceed to cascade the prompt to another LLM or inquire whether the user wishes to initiate such cascading.

Alternatively, the model can be trained using supervised learning on a dataset containing both high-quality and low-quality answers, negating the need for a specific corpus of ambiguous or unambiguous prompts. In this scenario, when a set of sample answers from an LLM lack functional/semantic equivalence, the model can classify one or more of these sample answers based on their quality. If the sample answers are assessed as high quality despite their lack of functional/semantic equivalence, it indicates an ambiguity in the prompt. Conversely, low-quality answers suggest that the LLM might struggle to provide a coherent response to the prompt.

In the case of high-quality answers, service 110 can prompt the user to refine or reformulate the prompt or undertake an automatic refinement or reformulation process. Following this, the same LLM can be reattempted with the improved prompt. In instances of low-quality answers, service 110 can query the user regarding their preference for cascading the prompt to another LLM, or it can autonomously cascade the prompt to an alternative LLM more likely to yield a lucid response to the prompt.

In certain instances, when an LLM generates a set of sample answers that lack functional/semantic equivalence, service 110 can furnish the user with a witness. This witness, also known as a counterexample, serves as evidence indicating non-functional/semantic equivalence between two domain-specific texts. Within this context, equivalence checker 108 can provide a “witness” to this non-equivalence scenario.

A witness, in this context, is a specific input or a set of inputs that, when inputted into both texts and executed as programs or otherwise evaluated, lead to divergent outputs. The presence of a witness offers concrete substantiation that the two texts do not share functional/semantic equivalence. To illustrate, the witness could encompass the assignment of a value or set of values to a parameter or a group of parameters within the respective functions delineated by the two texts in a programming language. Equivalence checker 108 ascertains that this value or set of values would result in distinct outputs when executed, thus showcasing the lack of functional/semantic equivalence between the two texts.

In certain scenarios, when an LLM generates a set of sample answers that lack functional/semantic equivalence, service 110 can offer a witness provided by equivalence checker 108. This witness, alongside the two non-equivalent texts, can be presented to the user. The user can then review the witness and the texts to determine whether it's more plausible that the prompt they provided is ambiguous or whether a more capable LLM is necessary to provide a correct response. Following the examination of the witness and texts, the user has the option to either refine or reformulate the prompt and reattempt the same LLM. Alternatively, the user can request service 110 to cascade the prompt to another LLM.

In certain instances, if the prompt undergoes refinement or reformulation multiple times (e.g., more than twice), and the same LLM consistently produces non-functionally/semantically equivalent sample answers on each occasion, this could suggest that the LLM is inadequate for generating a coherent response. If such a pattern emerges, service 110 can inquire whether the user wishes to proceed with cascading to another LLM.

In specific scenarios, if a prompt has been cascaded across multiple LLMs and none of the sampled LLMs yield functionally/semantically equivalent responses, service 110 might notify the user about the prompt's ambiguity and request them to enhance and rephrase the prompt. Subsequently, after the user refines and reformulates the prompt, service 110 can reset the cascade for the revised prompt, beginning from the initial LLM in the sequence (e.g., the lowest cost LLM). This is undertaken if the prompt's refinement or reformulation resolves the ambiguity, enabling a lower-cost LLM to provide a coherent response to the revised prompt.

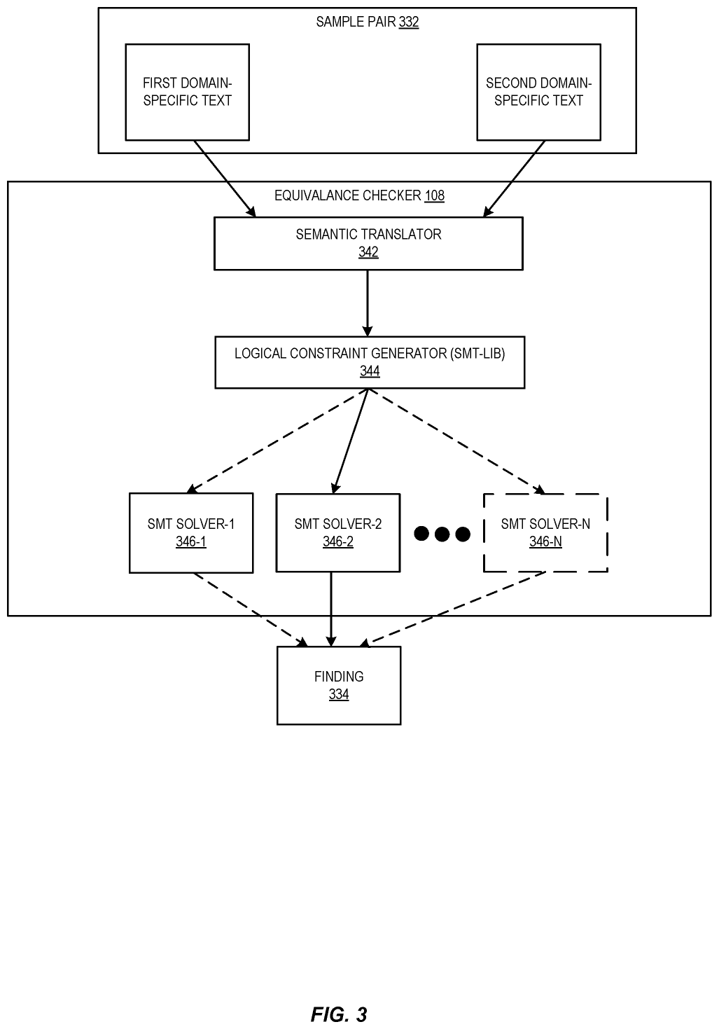

FIG. 3 presents an illustration of an equivalence checker designed to establish the functional/semantic equivalence of a pair of domain-specific texts. Equivalence checker 108 accepts a pair of domain-specific texts as input, denoted as the “first domain-specific text” or simply “first text,” and the “second domain-specific text” or just “second text.”

Sample pair 332 is input to semantic translator 342 within equivalence checker 108. Semantic translator 342 renders the domain-specific texts into a more structured and logical form, such as respective sets of logical assertions, while retaining their logical significance. These sets of assertions offer a more rigorous and logical depiction of the content of texts within pair 332.

The semantic encodings (e.g., sets of logical assertions) of the texts in sample pair 332, generated by semantic translator 342, are provided as input to logical constraint generator 344. Logical constraint generator 344 transforms these semantic encodings into logical formulas and mathematical (arithmetic) constraints, structured in a format that is appropriate for interpretation by an automated reasoning solver such as a satisfiability modulo theories (SMT) solver. A format that can be used for this purpose is SMT-LIB. However, other suitable solver encodings may be used.

Once the solver encodings of the texts in sample pair 332 are generated by logical constraint generator 344, they are merged with an additional solver constraint. This constraint affirms that the first domain-specific text yields a distinct output from the second domain-specific text for any possible input. If an automated reasoning solver yields an “unsatisfiable” outcome when processing this amalgamation of constraints, it signifies that there is no input for which the first and second domain-specific texts yield distinct outputs, implying their functional/semantic equivalence. Conversely, if the solver yields a “satisfiable” result, it indicates the presence of at least one input (the witness) for which the first and second domain-specific texts yield distinct outputs, confirming their non-functional/semantic equivalence.

In certain instances, equivalence checker 108 integrates multiple automated reasoning solvers, such as 346-1, 346-2, . . . 346-N, that operate in parallel or concurrently on the merged logical constraints generated by logical constraint generator 344 for sample pair 332. Employing diverse automated reasoning solvers can serve various purposes, including but not limited to the following reasons. Firstly, different automated reasoning solvers may apply distinct algorithms, heuristics, and optimization strategies. Employing multiple automated reasoning solvers for the same problem can provide insights into which ones perform optimally for specific inputs. Certain automated reasoning solvers might excel in particular domains or problem categories while encountering difficulties in others. Employing multiple automated reasoning solvers can enhance the likelihood that at least one of them yields a valid result. For instance, certain problems could entail intricate constraints or combinations of theories that challenge specific automated reasoning solvers. Employing multiple solvers could boost the chances of finding one capable of effectively handling such complexity.

If multiple automated reasoning solvers reach consensus on a result (e.g., “unsatisfiable”), this could enhance the confidence level in that outcome. Running numerous automated reasoning solvers concurrently on the same problem can expedite the search for a solution. For instance, equivalence checker 108 can trigger multiple automated reasoning solvers on the combined logical constraints and return the first finding generated by any of these solvers.

In certain scenarios, the methods for sampling and cascading large language models with equivalence checking facilitate software development within a cloud-based integrated development environment (IDE). Specifically, the IDE can leverage these approaches to automate code generation based on a provided code generation prompt from an IDE user.

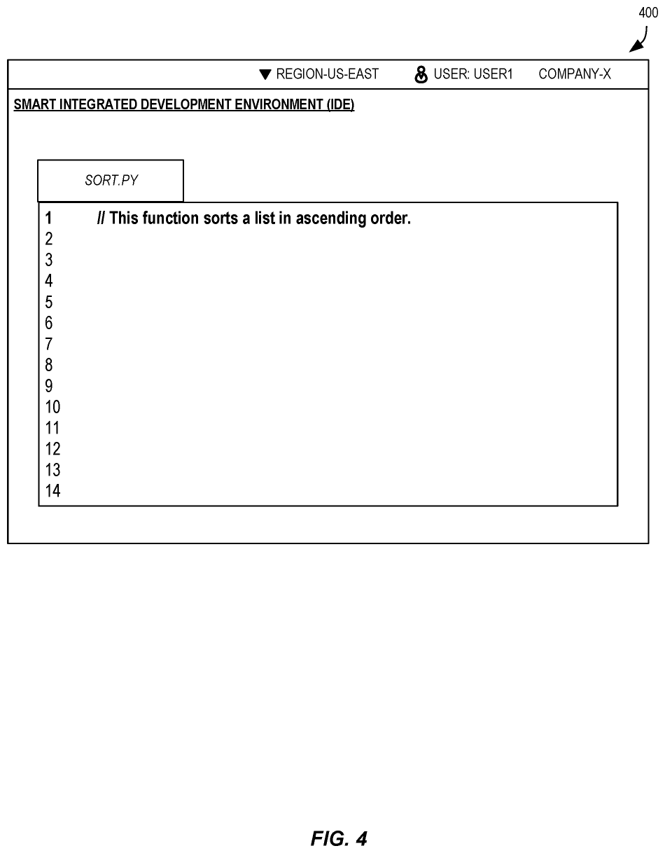

FIG. 4 illustrates an example of a graphical user interface (GUI) 400 for a smart integrated development environment (IDE) that employs the methods described herein for automated code generation. This intelligent IDE could be cloud-based or exist within other software development environments hosted by a provider network (such as provider network 100) and accessible via the internet or other intermediate network (such as intermediate network 102). The functionalities of the smart IDE can be carried out through a client application (like client application 124) on a user's device (e.g., customer device 122) within a network (e.g., customer network 120). This could involve utilizing a web browser, allowing software developers to work across different devices and locations without needing to install and configure software on their individual computing devices.

One of the functions of the smart IDE is code editing. This intelligent IDE offers a code editor equipped with features such as syntax highlighting, autocompletion, and other coding aids, allowing developers to write, edit, and format code directly within the IDE application or another graphical computing environment such as a web browser. For instance, the graphical user interface 400 depicted in FIG. 4 includes a code editor. In the example shown in FIG. 4, a user has initiated the coding process for a Python programming language file named “sort.py.” In the first line of the file, the user has entered a Python programming language comment that provides an explanation for the Python function they intend to code. In this particular instance, the user is aiming to create a function that sorts a list in ascending order.

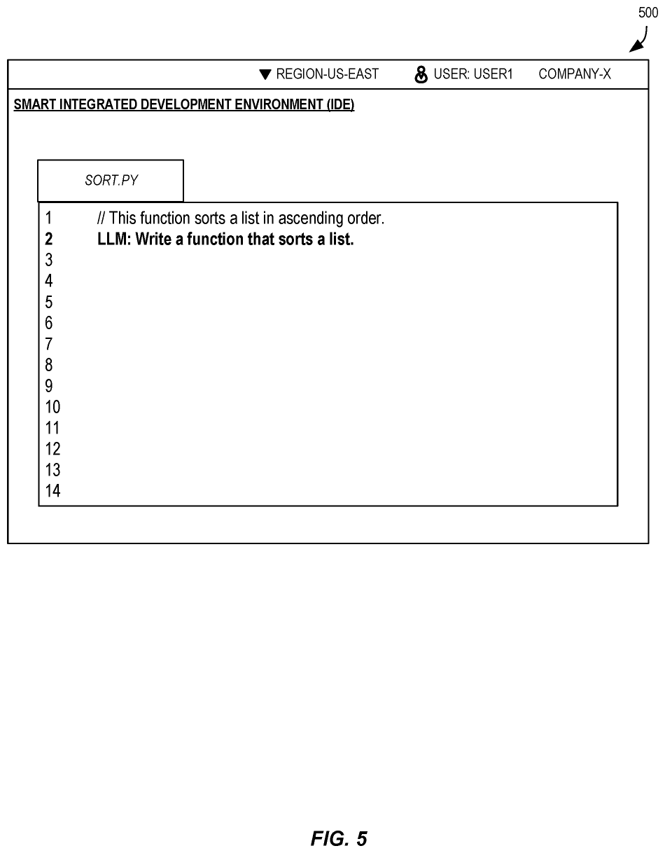

Turning now to FIG. 5, it illustrates an example graphical user interface (GUI) 500 to the smart integrated development environment (IDE) that uses disclosed techniques for automatic code generation. GUI 500 reflects a state of the code editor after the user has input the comment on line 1 as depicted in GUI 400 of FIG. 4 and after the user has entered a large language model code generation prompt on line 3. In this example, the prefix “LLM:” is interpreted as a command or signal to the smart IDE that the text that follows the prefix is generation prompt. In this example, prompt asks a LLM to generate a function that sorts a list. Note that the prompt is ambiguous in that does not specify how the list is to be sorted (e.g., in ascending order, in descending order, etc.)

In response to the input of the code generation prompt, the smart IDE sends the code generation prompt to service 110 via API 112. The code generation prompt can be sent to service 110 from the user's web browser (e.g., at customer device 122). Alternatively, the code generation prompt can first be sent to the smart IDE service in a provider network (e.g., provider network 100) and then sent from the smart IDE to service 110. In either case, service 110 can sample a Large Language Model (LLM) as described above with respect to FIG. 1, or sample and cascade over a set of LLMs as described above with respect to FIG. 2. A response is then returned to the user's web browser for input into the code editor.

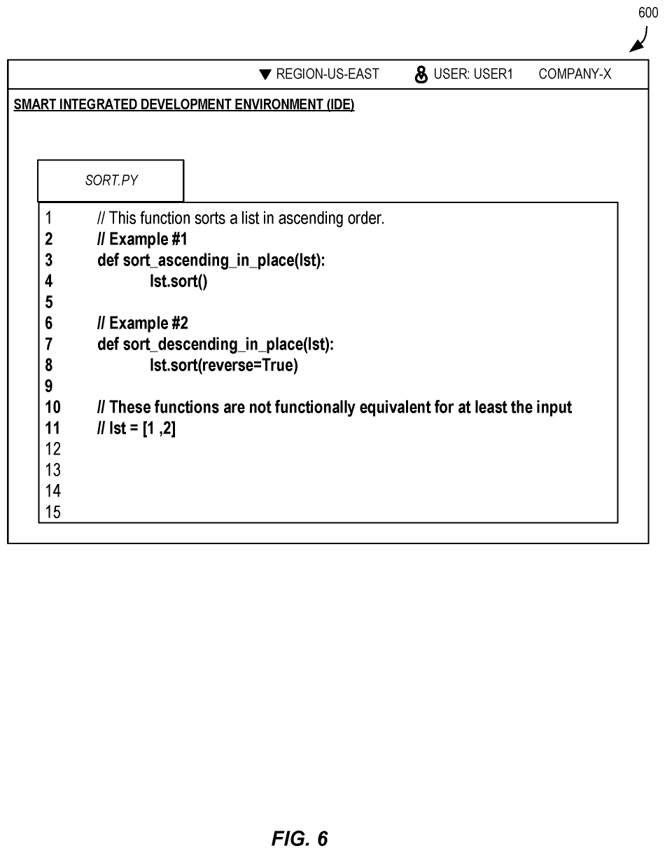

Turning now to FIG. 6, it illustrates an example of a graphical user interface (GUI) 600 for the smart IDE that employs the techniques disclosed herein for automatic code generation. GUI 600 reflects the state of the code editor after a response has been received. The smart IDE has automatically replaced the code generation prompt input to the code editor at line 2, as depicted in GUI 500 of FIG. 5, with the response at lines 2-11 of the code editor. Here, the equivalence checker 108 found samples to the prompt obtained from the LLM to be not functionally/semantically equivalent. In particular, the LLM generated one domain-specific text output in which the list is sorted in ascending order (lines 2-4), and another domain-specific text output where the list is sorted in descending order (lines 6-8). The response includes both outputs. Additionally, the response includes a witness (counterexample) at lines 10-11, returned by the equivalence checker 108, that demonstrates that the two domain-specific text outputs are not functionally/semantically equivalent. In this example, the two functions would sort the input list [1, 2] differently, one in ascending order ([1, 2]) and the other in descending order ([2, 1]). From the response, the user can readily determine that the original prompt was ambiguous.

Beneficially, with the techniques disclosed herein, the user can prompt a Large Language Model (LLM) to automatically generate domain-specific text from within a code editor of a smart IDE. The domain-specific text that is generated and returned to the user is likely to be a lucid answer to the user's prompt and unlikely to be a hallucination. In the context of code generation, a hallucination can take many forms such as being syntactically incorrect, being in the wrong programming language, being syntactically correct but functionally incorrect, etc. Further, LLM service costs may be reduced if the verified, domain-specific text can be obtained from a relatively low-cost LLM service.

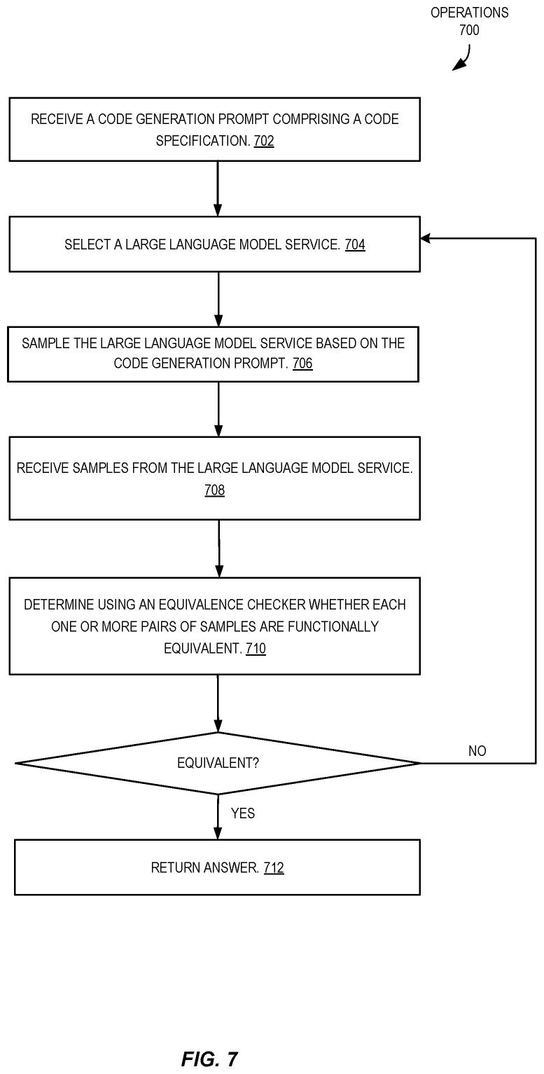

FIG. 7 illustrates an example of a method for sampling a large language model with equivalence checking. Some or all the operations 700 (or other processes described herein, or variations, and/or combinations thereof) are performed under the control of one or more computing devices configured with executable instructions. These operations are implemented as code (e.g., executable instructions, one or more computer programs, or one or more applications) collectively executing on one or more processors. The code is stored on a computer-readable storage medium. For example, it can be in the form of a computer program comprising instructions that are executable by one or more processors. The computer-readable storage medium is non-transitory. In some examples, one or more (or all) of the operations 700 are performed by service 110 and the automated reasoning service 104 of FIG. 1 and FIG. 2.

The operations 700 include, at block 702, receiving a code generation prompt comprising a code specification. For example, the service 110 can receive a high-level description or specification of the code to be generated by an LLM. This description or specification can be in natural language or structured form. The code specification defines what the code should achieve, the input and output behavior, any specific libraries, frameworks, or programming languages to be used, and any other relevant details. Upon receiving the code generation prompt, the cascading LLM service 110 may process the code specification to extract key details, such as function names, variable types, control flow structures, and any other important elements.

The operations 700 further include, at block 704, selecting a large language model service. For instance, the service 110 can choose the lowest-cost LLM service from a set of available options, or it can opt for the lowest-cost LLM service from the available options with a predicted probability of generating a functionally/semantically equivalent code specification that surpasses a certain threshold or minimum probability.

The operations 700 further include, at block 706, sampling the selected large language model service with the code generation prompt. For instance, the service 110 can transmit the code specification from the code generation prompt to the chosen large language model service on multiple occasions. In certain instances, the code generation prompt sent to the large language model service may not be identical to the code generation prompt received in the operation at block 702. As an example, the code generation prompt dispatched to the large language model service might encompass key details extracted by the service 110 from the code generation prompt received during the operation at block 702, in conjunction with the code specification. Moreover, in some cases, the service 110 might modify the code generation prompt received in the operation at block 702 and forward an adapted code generation prompt to the large language model service. For instance, the service 110 could reduce the size of the received code generation prompt by eliminating one or more examples included in the initial code generation prompt, or the service 110 could enlarge the received code generation prompt by including one or more examples.

The operations 700 further include, at block 708, receiving samples from the large language model service based on the sampling conducted in block 706. Each sample may encompass the output of a large language model given the code specification from a code generation prompt that outlines a specific coding task or instructions. For every sample, the large language model analyzes the code generation prompt and endeavors to produce code that meets the requirements or intentions expressed in the code specification of the code generation prompt. In pursuit of this goal, the large language model utilizes its acquired understanding of programming languages, syntax, and prevalent coding patterns to generate coherent and pertinent code.

The operations 700 also encompass, at block 710, the determination of whether each of the one or more pairs of samples received at block 706 is functionally/semantically equivalent using an equivalence checker. This equivalence checker could be a specialized automated theorem proving tool or software system (e.g., an SMT solver) configured to establish the equivalence of the two samples, presented in the form of logical formulas or theorems (e.g., as SMT-LIB constraints). Employing formal logic and mathematical reasoning, the equivalence checker determines whether the two samples are functionally/semantically equivalent, indicating that they yield identical outputs across all potential inputs. The two samples under comparison can be depicted in a formal language (e.g., SMT-LIB) or another variation of first-order logic, propositional logic, or higher-order logic.

If the result produced by the equivalence checker indicates that one of the pairs of samples is not functionally/semantically equivalent, the method may proceed by returning to the operation at block 704 to choose a new large language model service to which the code generation prompt received from the operation at block 702 or its processed version can be sent. For instance, the service 110 could opt for the next lowest-cost LLM service from the available options or select the next lowest-cost LLM service from the available options with a predicted probability of generating a functionally/semantically equivalent code specification surpassing a specific threshold or minimum probability. In certain scenarios, if the equivalence checker's outcome indicates that one of the pairs of samples is not functionally/semantically equivalent, the method might prompt the user to refine or rephrase the prompt received at block 702, instead of transitioning to the next LLM service in line. The same LLM service chosen in operation 704 can be utilized again, but this time with the refined or reformulated prompt. To assist the user in addressing the prompt's ambiguity, the user's prompt may present a piece of evidence returned by the equivalence checker, demonstrating that a pair of samples is not functionally/semantically equivalent.

Conversely, if the determination made by the equivalence checker is that every pair of samples is functionally/semantically equivalent, then the operations 700 additionally encompass, at block 712, the act of providing one or more of the sample responses received from the present large language model service as the answer to the code generation prompt received from the operation at block 702.

Some examples discussed herein involve sampling a single LLM with a prompt or multiple prompts. However, it is possible to sample multiple LLMs (e.g., in parallel) with the same prompt. For example, LLM A and LLM B could be sampled with prompt P to obtain domain-specific text A′ from LLM A and domain-specific text B′ from LLM B. Texts A′ and B′ could then be tested for functional/semantic equivalence (e.g., using equivalence checker 108). If the two texts A′ and B′ are functionality equivalent, then text A′, text B′, both texts A′ and B′, or a combination of A′ and B′ can be returned as an answer to the prompt P on the basis that since text A′ and text B′ are functionality/semantically equivalent, it is likely that these texts A′ and B′ are coherent or correct answers to the prompt P.

If the two texts A′ and B′ are not functionally/semantically equivalent, then a determination may be made as to whether the prompt P is malformed, incorrect, or ambiguous or that either or both LLM A and LLM B were not capable of returning a coherent or correct answer to prompt P. In the case that it is suspected that either or both LLM A and LLM B was not capable of returning a coherent or correct answer to prompt P, then the prompt P may be cascaded to LLM C to obtain text C′. Text C′ may be tested for functional/semantic equivalence with either or both text A′ and text B′. If text C′ is functionally/semantically equivalent to either text A′ or text B′, then either of the functionally/semantically equivalent texts, both the functionally/semantically equivalent texts, or a combination of the functionally/semantically equivalent texts can be returned as an answer to the prompt P on the probability that one of the LLMs A or B was unable to generate a coherent or correct response to the prompt P and on the basis that since two texts from two different LLMs are functionality equivalent, it is likely that the functionally/semantically equivalent texts are coherent or correct answers to the prompt P. If text C′ is not functionally/semantically equivalent to both text A′ and text B′, then the probability that prompt P is malformed, incorrect, or ambiguous may be greater because no pair of domain-specific texts output by three different LLMs for the same prompt is functionally/semantically equivalent.

Alternatively, in the case that it is suspected that either or both LLM A and LLM B was not capable of returning or coherent or correct answer to prompt P, the prompt P may be cascaded to LLM C and LLM D to obtain domain-specific text C′ from LLM C and domain-specific text D′ from LLM D. Texts C′ and D′ could then be tested for functional/semantic equivalence (e.g., using equivalence checker 108). If the two texts C′ and C′ are functionality equivalent, then text C′, text D′, both texts C′ and D′, or a combination of C′ and D′ can be returned as an answer to the prompt P on the basis that since text C′ and text D′ are functionality/semantically equivalent, it is likely that these texts C′ and D′ are coherent or correct answers to the prompt P.

If the two texts C′ and D′ are not functionally/semantically equivalent, then a another determination may be made as to whether the prompt P is malformed, incorrect, or ambiguous or that either or both LLM C and LLM D were not capable of returning a coherent or correct answer to prompt P. In the case that it is suspected that either or both LLM A and LLM B was not capable of returning a coherent or correct answer to prompt P, then the prompt P may likewise further cascaded to additional LLMs should additional LLMs be available.

Examples herein involve sampling large language models (LLMs). LLMs are a subset of foundational models specifically designed to understand and generate human-like text. They are often used for NLP tasks. LLMs are primarily used for tasks involving text, including but not limited to text completion, summarization, translation, question answering, and conversation. GPT-3, GPT-4, BERT, and RoBERTa are examples of LLMs. Like foundational models, LLMs are typically pre-trained on a broad language modeling task and then fine-tuned for specific NLP tasks.

While examples herein involve sampling LLMs, the sampling and cascading techniques herein can be applied more generally to foundation models. A foundational model and a large language model (LLM) refer to classes of large-scale machine learning models that are trained on substantial amounts of data and can be fine-tuned or adapted for various tasks. A foundational model is a pre-trained model that serves as a starting point for building more specialized models. These models are trained on extensive data from diverse sources, capturing wide-ranging knowledge and capabilities. Foundational models can be used in various applications, including natural language processing (NLP), computer vision, and others. Foundational models are not limited to text. GPT-3, BERT, and computer vision models like ResNet can all be considered foundational models since they provide a base for diverse applications. They are usually pre-trained on a broad task (e.g., language modeling or image classification) and then fine-tuned for specific applications.

Thus, in summary, a foundational model refers to a large pre-trained model that can be used as a base for various applications across different domains, including but not limited to text. A large language model (LLM) refers to a specialized type of foundational model focused on processing and generating text. While all LLMs may be considered foundational models, not all foundational models are LLMs. The sampling and cascading techniques disclosed herein can be used with foundational models including LLMs.

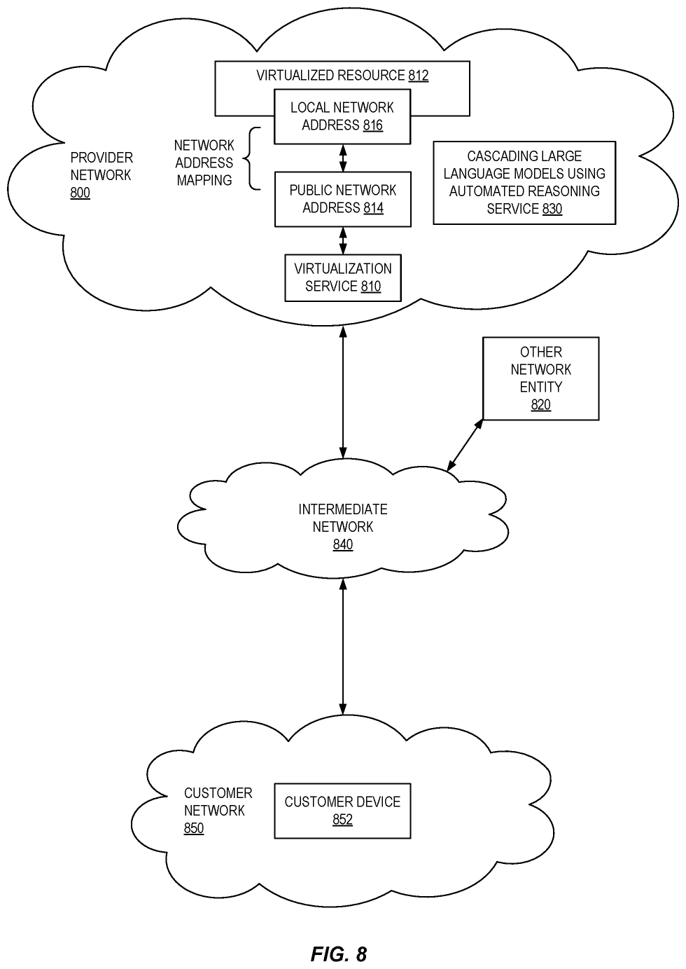

FIG. 8 illustrates an example of a provider network environment in which the techniques for sampling and cascading large language models with equivalence checking are used. Provider network 800 encompasses the infrastructure and architecture established by a cloud service provider to deliver cloud services and virtualized resources to customers. Provider network 800 may be distributed over multiple data centers in different geographic regions. Each data center houses the physical hardware and servers that host the virtualized resources, applications, and services provided by the cloud service provider. The purpose of provider network 800 is to enable customers to access and utilize cloud-based services, applications, and virtualized resources over the internet from their customer networks (e.g., customer network 850) and using their computing devices (e.g., customer device 852) securely and efficiently. While only one customer network and one customer device are depicted in FIG. 8 for the purpose of providing a clear example, provider network 800 may be accessed by many customer networks and many customer devices.

In addition to providing sampling and cascading large language models with equivalence checking service 830, provider network 800 may provide virtualization service 810 that allows customers to use virtualized resources (e.g., virtualized resource 812) in provider network 800. While only a single virtualized resource is depicted in FIG. 8 for the sake of providing a clear example, provider network 800 may encompass zero or many virtualized resources. Thus, virtualized resource 812 generically represents one of potentially many virtualized resources in provider network 800. Virtualized resource 812 can be one of various types of virtualized resources that may exist in provider network 800 including, for example, a virtual machine, a container, a virtual router, a virtual switch, a virtual load balancer, a virtual firewall, a virtual network interface, a virtual network service, or any other suitable type of virtualized resource.

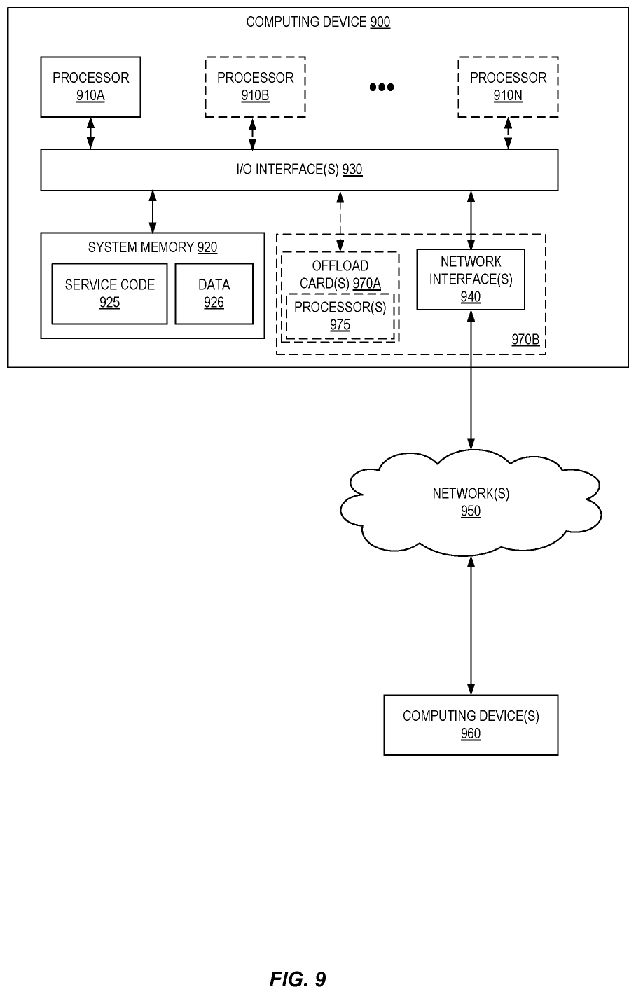

Virtualization service 810 allows multiple virtualized resources (e.g., virtualized resource 812), such as operating systems, servers, storage, or networks, to run on a single physical hardware platform (e.g., computing device 900 of FIG. 9). Virtualization service 810 may use various technologies to accomplish virtualization including any or all of: a hypervisor or a virtual machine monitor or other software or firmware that creates and manages virtual machines, a virtual machine or other emulation of a physical computer that is capable of running its own operating system and applications independently from a host system and other virtual machines on the same hardware, a host system or a physical server or computer that runs the hypervisor/virtual machine monitor and host virtual machines, guest operating systems installed on each virtual machine that behave as if they were running on a dedicated physical machine, or other suitable virtualization technology.

By implementing virtualization via virtualization service 810, provider network 800 provides several benefits to customers and the cloud service provider. Virtualization allows better utilization of underlying hardware resources by running multiple virtual machines on a single physical server resulting in cost savings and more efficient use of computing power. Each virtual machine is isolated from others to a degree, providing security and fault tolerance such that if a virtual machine crashes or experiences an issue, it does not affect other virtual machines on the same host system. Virtualization allows easy creation, deletion, and migration of virtual machines, enabling greater flexibility and scalability in managing the provider network environment. Virtualization enables rapid software testing and development, as it allows developers to create multiple environments quickly and without the need for separate physical hardware.

Additionally, or alternatively, virtualization provided by virtualization service 810 encompasses containerization technologies. Containerization is a form of virtualization that allows software applications and their dependencies to be packaged and isolated into self-container units called containers. Each container includes the application, runtime, libraries, and other necessary components, ensuring that the application runs consistently and reliably across different environments. Containerization provides a lightweight, portable, and scalable solution for deploying and managing software applications. Containers share the host system's operating system kernel, which makes them more efficient than virtual machines that require separate guest operating systems. This allows containers to start and stop quickly, using fewer resources, and scale easily.

Provider network 800 uses public network addresses (e.g., public network address 814) and local IP addresses (e.g., local network address 814) to provide virtualized resources to customers. Provider network 800, via virtualization services 810, allows public network address 814 and local network address 816 to be associated with virtualized resource 812 provisioned to a customer. Public network address 814 may be one of many public network addresses used by provider network 800. Likewise for local network address 816. Thus, public network address 814 and local network address 816 generically represent a public network address and local network address respectively used by provider network 800 to provide a virtualized resource. Both public network address 814 and local network address 814 may be an internet protocol (IP) network address such as, for example, an IPV4 or IPv6 network address. Local network address 816 can be a private network address within an address block reserved by Internet Engineering Task Force (IETF) Request for Comments (RFC) 1918 or of an address format specified by IETF RFC 4193 or other type of private network address.

Using resource 812 and public network address 814, a customer can implement a customer-specific application and present the application on intermediate network 840 (e.g., the internet). Network traffic originating outside provider network 800 is not directly routed to local network address 816. Instead, the network traffic uses public network address 814 that is mapped to local IP address 816. Provider network 800 can include a networking device or appliance that provides network address translation (NAT) or similar functionality to perform forward mapping from public IP address 814 to local IP address 816. Another network entity 820 on intermediate network 840 can generate network traffic (e.g., internet protocol (IP) packets) to public network address 814. The network traffic destined for public network address 814 is routed via intermediate network 840 to provider network 800. The received network traffic is routed within provider network 800 to local network address 816 and to virtualized resource 812 that processes the network traffic. Network traffic generated by virtualized resource 812 may be routed onto intermediate network 840 to network entity 820.

FIG. 9 illustrates an example of a computing device used to implement techniques for sampling and cascading large language models with equivalence checking. In some examples, a system that implements a portion or all the techniques described herein can include a general-purpose computer system, such as the computing device 900 (also referred to as a computing system or electronic device) illustrated in FIG. 9, that includes, or is configured to access, one or more computer-accessible media. In the illustrated example, the computing device 900 includes one or more processors 910 coupled to a system memory 920 via an input/output (I/O) interface 930. The computing device 900 further includes a network interface 940 coupled to the I/O interface 930. While FIG. 9 shows the computing device 900 as a single computing device, in various examples the computing device 900 can include one computing device or any number of computing devices configured to work together as a single computing device 900.

In various examples, the computing device 900 can be a uniprocessor system including one processor 910, or a multiprocessor system including several processors 910 (e.g., two, four, eight, or another suitable number). The processor(s) 910 can be any suitable processor(s) capable of executing instructions. For example, in various examples, the processor(s) 910 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 910 can commonly, but not necessarily, implement the same ISA.

The system memory 920 can store instructions and data accessible by the processor(s) 910. In various examples, the system memory 920 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 920 as service code 925 (e.g., executable to implement, in whole or in part, service 110 and automated reasoning service 104 of FIG. 1 or FIG. 2) and data 926.

In some examples, the I/O interface 930 can be configured to coordinate I/O traffic between the processor 910, the system memory 920, and any peripheral devices in the device, including the network interface 940 and/or other peripheral interfaces (not shown). In some examples, the I/O interface 930 can perform any necessary protocol, timing, or other data transformations to convert data signals from one component (e.g., the system memory 920) into a format suitable for use by another component (e.g., the processor 910). In some examples, the I/O interface 930 can include support for devices attached through various types of peripheral buses, such as a variant of the Peripheral Component Interconnect (PCI) bus standard or the Universal Serial Bus (USB) standard, for example. In some examples, the function of the I/O interface 930 can be split into two or more separate components, such as a north bridge and a south bridge, for example. Also, in some examples, some or all the functionality of the I/O interface 930, such as an interface to the system memory 920, can be incorporated directly into the processor 910.

The network interface 940 can be configured to allow data to be exchanged between the computing device 900 and other computing devices 960 attached to a network or networks 950, such as other computer systems or devices as illustrated in FIG. 1, for example. In various examples, the network interface 940 can support communication via any suitable wired or wireless general data networks, such as types of Ethernet network, for example. Additionally, the network interface 940 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 900 includes one or more offload cards 970A or 970B (including one or more processors 975, and possibly including the one or more network interfaces 940) that are connected using the I/O interface 930 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 900 can act as a host electronic device (e.g., operating as part of a hardware virtualization service) that hosts compute resources such as compute instances, and the one or more offload cards 970A or 970B execute a virtualization manager that can manage compute instances that execute on the host electronic device. As an example, in some examples the offload card(s) 970A or 970B can perform compute instance management operations, such as pausing and/or un-pausing compute instances, launching and/or terminating compute instances, performing memory transfer/copying operations, etc. These management operations can, in some examples, be performed by the offload card(s) 970A or 970B in coordination with a hypervisor (e.g., upon a request from a hypervisor) that is executed by the other processors 910A-910N of the computing device 900. However, in some examples the virtualization manager implemented by the offload card(s) 970A or 970B can accommodate requests from other entities (e.g., from compute instances themselves), and cannot coordinate with (or service) any separate hypervisor.

In some examples, the system memory 920 can be one example of a computer-accessible medium configured to store program instructions and data as described above. However, in other examples, program instructions and/or data can be received, sent, or stored upon different types of computer-accessible media. A computer-accessible medium can include any non-transitory storage media or memory media such as magnetic or optical media, e.g., disk or DVD/CD coupled to the computing device 900 via the I/O interface 930. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 900 as the system memory 920 or another type of memory. Further, a computer-accessible medium can include transmission media or signals such as electrical, electromagnetic, or digital signals, conveyed via a communication medium such as a network and/or a wireless link, such as can be implemented via the network interface 940.

Various examples discussed or suggested herein can be implemented in a wide variety of operating environments, which in some cases can include one or more user computers, computing devices, or processing devices which can be used to operate any of a number of applications. User or client devices can include any of several general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected to, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 114-1-114-N) can be used to indicate that there can be one or multiple instances of the referenced entity in various examples, and when there are multiple instances, each does not need to be identical but may instead share some general traits or act in common ways. Further, the suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method for sampling and cascading large language models (LLMs) with equivalence checking, the method performed by one or more computing devices, the method comprising:
receiving a prompt;
sampling a first large language model (LLM) based on the prompt to obtain a first set of sample answers generated by the first LLM, each sample answer of the first set of sample answers comprising a respective domain-specific text;
using an equivalence checker to determine that a first pair of respective domain-specific texts of the first set of sample answers are not equivalent;
sampling a second large language model (LLM) based on the prompt to obtain a second set of sample answers generated by the second LLM, each sample answer of the second set of sample answers comprising a respective domain-specific text;
using an equivalence checker to determine that a second pair of respective domain-specific texts of the second set of sample answers are equivalent;
determining, based on the domain-specific texts of the second pair, a particular domain-specific text for display in a graphical user interface; and
providing the particular domain-specific text for display in a graphical user interface.

2. The computer-implemented method of claim 1, wherein the prompt is expressed in a natural language.

3. The computer-implemented method of claim 1, wherein each sample answer of the first set of answers comprises a respective definition of a function in a programming language.

4. A computer-implemented method performed by one or more computing devices, the method comprising:
receiving a first prompt;
sampling a large language model (LLM) based on the first prompt to obtain a first set of sample answers generated by the first LLM, each sample answer of the first set of sample answers comprising a respective domain-specific text;
using an equivalence checker to determine that a first pair of respective domain-specific texts of the first set of sample answers are not equivalent;
receiving a second prompt, wherein the second prompt is a refinement of the first prompt;
sampling the large language model (LLM) based on the second prompt to obtain a second set of sample answers generated by the second LLM, each sample answer of the second set of sample answers comprising a respective domain-specific text;
using an equivalence checker to determine that a second pair of respective domain-specific texts of the second set of sample answers are equivalent;
determining, based on the domain-specific texts of the second pair, a particular domain-specific text for display in a graphical user interface; and
providing the particular domain-specific text for display in a graphical user interface.

5. The computer-implemented method of claim 4, wherein the first prompt and the second prompt are expressed in a natural language.

6. The computer-implemented method of claim 4, wherein each sample answer of the first set of answers comprises a respective definition of a function in a programming language.

7. The computer-implemented method of claim 4, wherein each sample answer of the first set of answers comprises a respective structure query language (SQL) query.

8. The computer-implemented method of claim 4, wherein the equivalence checker comprises a satisfiability modulo theories (SMT) solver; and wherein using the equivalence checker to determine that the second pair of respective domain-specific texts of the second set of sample answers are equivalent is based on the SMT solver determining that a set of logical constraints representing the first pair of respective domain-specific texts is unsatisfiable.

9. The computer-implemented method of claim 4, wherein the equivalence checker comprises a satisfiability modulo theories (SMT) solver; and wherein using the equivalence checker to determine that the first pair of respective domain-specific texts of the first set of sample answers are not equivalent is based on the SMT solver determining that a set of logical constraints representing the first pair of respective domain-specific texts is satisfiable.

10. The computer-implemented method of claim 4, further comprising:
obtaining a witness from the equivalence checker for the first pair of respective domain-specific texts, the witness comprising a counterexample to equivalence of the first pair of texts; and
presenting the counterexample to equivalence of the first pair of texts in a graphical user interface.

11. The computer-implemented method of claim 4, wherein using the equivalence checker to determine that the second pair of respective domain-specific texts of the second set of sample answers are equivalent is based on:
encoding a first domain-specific text of the second pair and a second domain-specific text of the second pair according to a satisfiability modulo theories library (SMT-LIB) standard to yield a first SMT-LIB encoding of the first domain-specific text and a second SMT-LIB specification of the second domain-specific text;
combining the first SMT-LIB encoding and the second SMT-LIB encoding to yield a combined SMT-LIB encoding; and
inputting the combined SMT-LIB encoding into a SMT solver.

12. The computer-implemented method of claim 11, inputting the combined SMT-LIB encoding into each of a plurality of SMT solvers.

13. The computer-implemented method of claim 4, wherein the first prompt is received by a service in a provider network from a customer device in a customer network; and wherein the particular domain-specific text is returned by the server in the provider network to the customer device in the customer network.

14. The computer-implemented method of claim 4, wherein the large language model (LLM) is a first LLM, and whether the method further comprises:
prior to sampling the first large language model based on the first prompt:
sampling a second large language model (LLM) based on the first prompt to obtain a third set of sample answers generated by the second LLM, each sample answer of the third set of sample answers comprising a respective domain-specific text;
using the equivalence checker to determine that a third pair of respective domain-specific texts of the third set of sample answers are not equivalent; and
determining to sample the first large language model (LLM) based on the first prompt based on determining that the third pair of respective domain-specific texts of the third set of sample answers are not equivalent.

15. A system comprising:
a first one or more computing devices to implement a sampling large language model service in a multi-tenant provider network, the sampling large language model service including instructions that upon execution cause the sampling large language model service to:
receive a first prompt;
sample a large language model (LLM) based on the first prompt to obtain a first set of sample answers generated by the first LLM, each sample answer of the first set of sample answers comprising a respective domain-specific text;
receive a second prompt, wherein the second prompt is a refinement of the first prompt;
sample the large language model (LLM) based on the second prompt to obtain a second set of sample answers generated by the second LLM, each sample answer of the second set of sample answers comprising a respective domain-specific text;
a second one or more computing devices to implement an automated reasoning service in the multi-tenant provider network, the automated reasoning service including instructions that upon execution cause the automated reasoning service to:
determine, using an equivalence checker, that a first pair of respective domain-specific texts of the first set of sample answers are not equivalent; and
determine, using the equivalence checker, that a second pair of respective domain-specific texts of the second set of sample answers are equivalent.

16. The system of claim 15, wherein the first prompt and the second prompt are expressed in a natural language.

17. The system of claim 15, wherein each sample answer of the first set of answers comprises a respective definition of a function in a programming language.

18. The system of claim 15, wherein each sample answer of the first set of answers comprises a respective structure query language (SQL) query.

19. The system of claim 15, wherein the equivalence checker comprises a satisfiability modulo theories (SMT) solver; and wherein using the equivalence checker to determine that the second pair of respective domain-specific texts of the second set of sample answers are equivalent is based on the SMT solver determining that a set of logical constraints representing the first pair of respective domain-specific texts is unsatisfiable.

20. The system of claim 15, wherein the equivalence checker comprises a satisfiability modulo theories (SMT) solver; and wherein using the equivalence checker to determine that the first pair of respective domain-specific texts of the first set of sample answers are not equivalent is based on the SMT solver determining that a set of logical constraints representing the first pair of respective domain-specific texts is satisfiable.
